(19) United States
(12) Patent Application Publication
(10) Pub. No.: US 2011/0004853 A1
(43) Pub. Date: Jan. 6, 2011

(54) Method for multiple touch modes, method for applying multi single-touch instruction and electronic device performing these methods

(75) Inventor: Yao-Tsung Chang, Taipei Hsien (TW)

Correspondence Address: BACON & THOMAS, PLLC, 625 SLATERS LANE, FOURTH FLOOR, ALEXANDRIA, VA, 22314-1176, US

(73) Assignee: Wistron Corporation, Taipei Hsien (TW)

(21) Appl. No.: 12/588,638

(22) Filed: Oct. 22, 2009

(30) Foreign Application Priority Data
Jul. 3, 2009 (TW) 098122586

(51) Int. Cl. G06F 3/033

(52) U.S. Cl. 715/863; 345/173

(57) ABSTRACT

A method for multiple touch modes, a method for applying multi single-touch instruction, and an electronic device performing these methods are disclosed. The method for multiple touch modes comprises the following steps: receiving at least one instruction; determining whether the at least one instruction comprises a start instruction; if yes, determining whether the at least one instruction is a multi single-touch instruction; and if yes, performing a multi single-touch operation corresponding to the at least one instruction.

### BACKGROUND OF THE INVENTION

1. Field of the Invention

The present invention relates to a method for multiple touch modes, a method for applying multi single-touch instruction, and an electronic device performing these methods; more particularly, the present invention relates to a method for multiple touch modes capable of achieving the same function of a multi-touch instruction by means of a multi single-touch instruction, a method for applying multi single-touch instruction, and an electronic device performing these methods.

2. Description of the Related Art

Please refer to FIG. 1A, which illustrates a schematic drawing of a single-touch instruction according to a known prior art. As shown in FIG. 1A, a conventional touch device is only capable of processing single-touch instructions. That is, the conventional touch device can only process an instruction corresponding to a single touch gesture at a time.

Since the appearance of a multi-touch technique, it has been applied in various kinds of touch devices. Please refer to FIG. 1B, which illustrates a schematic drawing of a multi-touch instruction according to another known prior art. As shown in FIG. 1B, a multi-touch instruction can receive multiple touch gestures such as a first touch gesture and a second touch gesture at the same time, and then perform a corresponding instruction composed of the multiple touch gestures.

However, although the multi-touch operation has convenience, it still may cause some problem to users. For example, because at least two fingers are required to perform the multi-touch operation, it is very inconvenient for users who cannot use two fingers to perform the multi-touch operation at the same time due to some finger problems or other reasons. It would be much easier to consumers/users if the effect of the multi-touch operation can be accomplished by way of a single-touch operation.

Therefore, there is a need to provide a method for multiple touch modes, a method for applying multi single-touch instruction, and an electronic device performing these methods to mitigate and/or obviate the aforementioned problems.

### SUMMARY OF THE INVENTION

It is an object of the present invention to provide a method for multiple touch modes, a method for applying multi single-touch instruction, and an electronic device performing these methods.

To achieve the abovementioned object, the present invention provides a method for multiple touch modes used in an electronic device, wherein the electronic device comprises a touch device. The method for multiple touch modes comprises the following steps: receiving at least one instruction; determining whether the at least one instruction comprises a start instruction; if the at least one instruction comprises the start instruction, determining whether the at least one instruction is a multi single-touch instruction; if the at least one instruction is determined as the multi single-touch instruction, performing a multi single-touch operation corresponding to the at least one instruction.

In one embodiment of the present invention, the step of determining whether the at least one instruction comprises the start instruction further comprises the following steps: determining whether the at least one instruction comprises an end instruction; and if the at least one instruction comprises the start instruction and the end instruction, determining whether the at least one instruction is the multi single-touch instruction.

In one embodiment of the present invention, the electronic device further comprises a switch key, and the at least one instruction is an instruction formed via a touch gesture or the switch key. In one embodiment of the present invention, the start instruction is a start gesture or the switch key, and the end instruction is an end gesture or the switch key.

To achieve the abovementioned object, the present invention further provides a method for applying multi single-touch instruction used in an electronic device, wherein the electronic device comprises a touch device. The method for applying multi single-touch instruction is used for storing a multi single-touch instruction in a database, wherein the multi single-touch instruction comprises a plurality of single-touch gestures. The method for applying multi single-touch instruction comprises the following steps: receiving at least one instruction; determining whether the at least one instruction comprises a start instruction; if the at least one instruction comprises the start instruction, comparing the at least one instruction with a database for determining whether the at least one instruction is an effective multi single-touch instruction; and if the at least one instruction is the effective multi single-touch instruction, performing a multi single-touch operation corresponding to the at least one instruction.

In one embodiment of the present invention, after the step of determining whether the at least one instruction comprises the start instruction, the method of the present invention further comprises the following steps: if the at least one instruction comprises the start instruction, determining whether the at least one instruction comprises an end instruction; and if the at least one instruction comprises the end instruction, comparing the at least one instruction with the database for determining whether the at least one instruction is the effective multi single-touch instruction.

To achieve the abovementioned object, the present invention provides an electronic device, which comprises a processor, a storage device and a touch device. The storage device is electrically connected with the processor, and the storage device comprises a program and a database. The touch device is electrically connected with the processor, and the touch device is used for receiving a touch gesture from a user. By means of utilizing the processor to execute the program and the database, the electronic device is capable of performing the following steps: receiving at least one instruction; determining whether the at least one instruction comprises a start instruction; if the at least one instruction comprises the start instruction, determining whether the at least one instruction is a multi single-touch instruction; and if the at least one instruction is determined as the multi single-touch instruction, performing a multi single-touch operation corresponding to the at least one instruction.

Other objects, advantages, and novel features of the invention will become more apparent from the following detailed description when taken in conjunction with the accompanying drawings.

### BRIEF DESCRIPTION OF THE DRAWINGS

These and other objects and advantages of the present invention will become apparent from the following description of the accompanying drawings, which disclose several embodiments of the present invention. It is to be understood that the drawings are to be used for purposes of illustration only, and not as a definition of the invention.

In the drawings, wherein similar reference numerals denote similar elements throughout the several views:

FIG. 1A illustrates a schematic drawing of a single-touch instruction according to a known prior art.

FIG. 1B illustrates a schematic drawing of a multi-touch instruction according to another known prior art.

FIG. 2 illustrates a schematic drawing of a multi single-touch instruction according to one embodiment of the present invention.

FIG. 3 illustrates a hardware structure drawing of an electronic device according to one embodiment of the present invention.

FIG. 4 illustrates a schematic drawing of the electronic device according to one embodiment of the present invention.

FIG. 5 illustrates a flowchart of a method for applying multi single-touch instruction according to one embodiment of the present invention.

FIG. 6 illustrates a schematic drawing of a start instruction according to one embodiment of the present invention.

FIG. 7A illustrates a schematic drawing showing touch gestures of a multi single-touch operation according to one embodiment of the present invention.

FIG. 7B illustrates a schematic drawing showing touch gestures of a multi single-touch operation according to one embodiment of the present invention.

FIG. 8 illustrates a flowchart of a method for multiple touch modes according to one embodiment of the present invention.

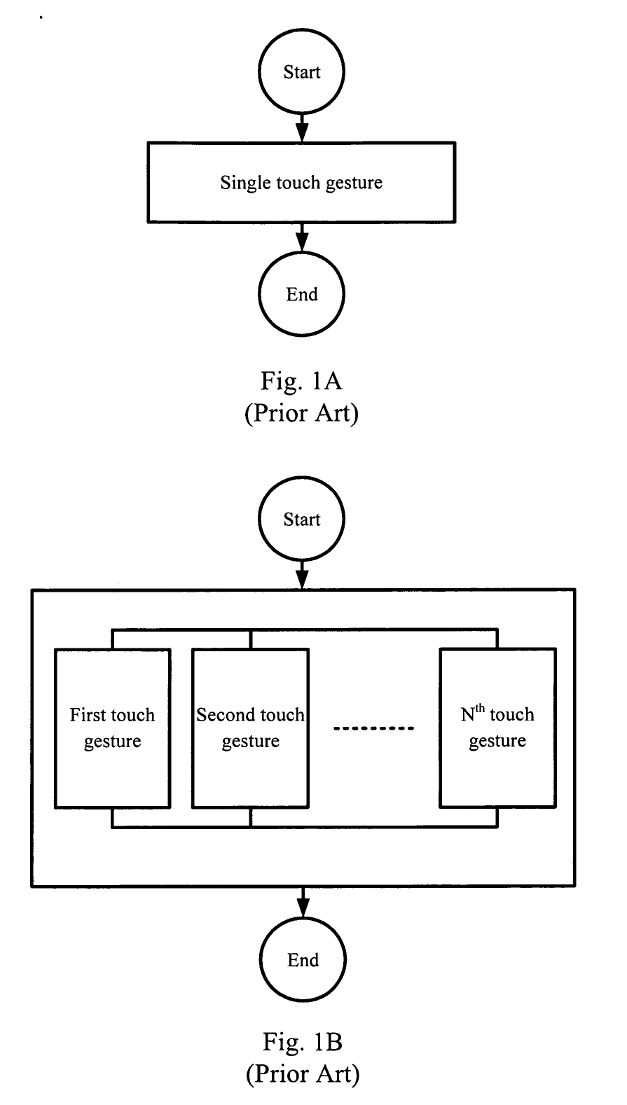

### DETAILED DESCRIPTION OF THE PREFERRED EMBODIMENT

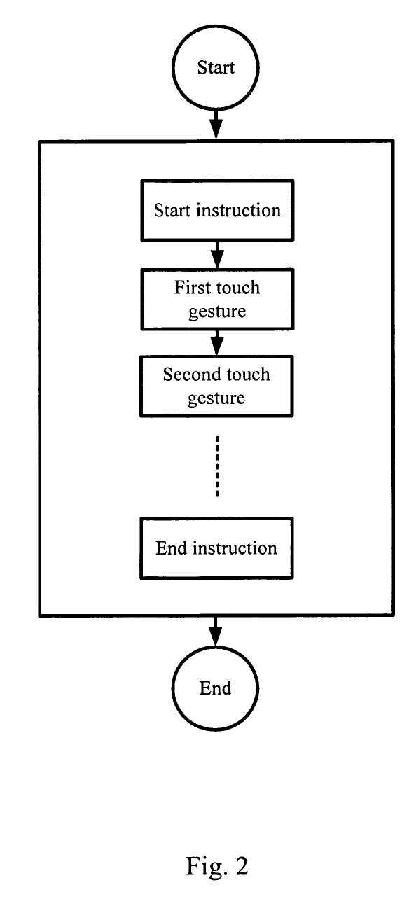

Please refer to FIG. 2, which illustrates a schematic drawing of a multi single-touch instruction according to one embodiment of the present invention.

As shown in FIG. 2, the multi single-touch instruction of the present invention allows a user to sequentially input instructions, including a start instruction, a first touch gesture, a second gesture, and an end instruction, via only one finger. Its related embodiments will be described hereinafter in more detail.

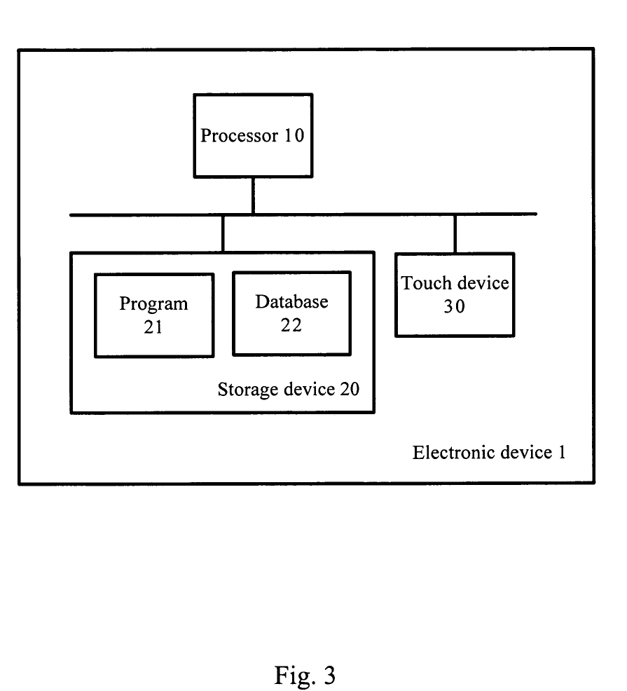

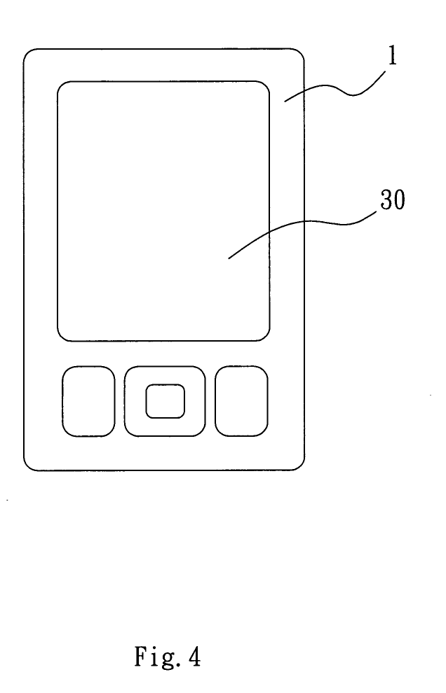

Now please refer to FIG. 3, which illustrates a hardware structure drawing of an electronic device 1 according to one embodiment of the present invention. The electronic device 1 of the present invention comprises a processor 10, a storage device 20 and a touch device 30. The storage device 20 is electrically connected with the processor 10, and the storage device 20 comprises a program 21 and a database 22. The touch device 30 is electrically connected with the processor 10, and the touch device 30 is used for receiving a touch gesture from a user.

Please refer to FIG. 4, which illustrates a schematic drawing of the electronic device 1 according to one embodiment of the present invention. In one embodiment of the present invention, the electronic device 1 is a personal digital assistant (PDA), and the touch device 30 is a touch screen, such that the user can use his/her finger to perform a touch gesture on the touch device 30. The processor 10 searches for an operation corresponding to the touch gesture via the program 21 or the database 22. Please note that the scope of the method for multiple touch modes or the method for applying multi single-touch instruction of the present invention is not limited to application in the electronic device 1 (i.e. the PDA) as shown in FIG. 3 and FIG. 4. For example, the electronic device 1 can also be a tablet PC, a notebook computer, a desktop computer, a monitor, a mobile phone, a music player (such as a MP3 player), a digital frame, a global positioning system (GPS) device, an electronic entertainment device, or other equivalent electronic device.

Please refer to FIGS. 2 to 7B. Steps of one embodiment of the method for applying multi single-touch instruction of the present invention will be described hereinafter by means of utilizing the electronic device 1 of the present invention.

A first implementation of the method for applying multi single-touch instruction is to store a multi-touch instruction into the database 22, and then to decompose the multi-touch instruction into a plurality of single-touch gestures. A second implementation of the method for applying multi single-touch instruction is to predefine a multi single-touch instruction. The multi single-touch instruction of the present invention comprises a plurality of single-touch gestures, and the plurality of single-touch gestures is composed to form a multi single-touch instruction. However, please note that the scope of the present invention is not limited to the above description. For example, the multi single-touch instruction further comprises a switch key, which will be described hereinafter in more detail.

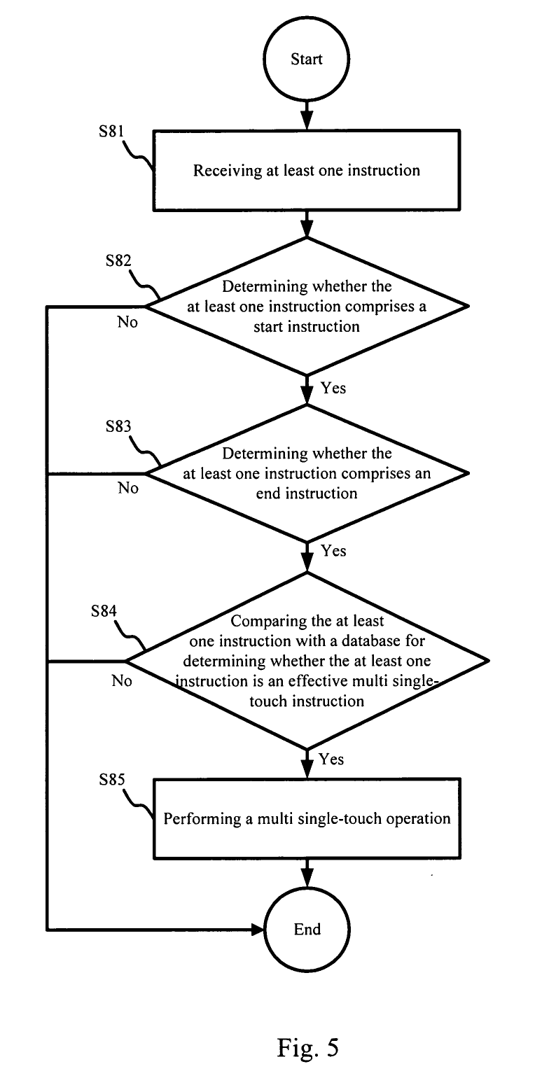

As shown in FIG. 5, the method for applying multi single-touch instruction of the present invention firstly performs step S81: receiving at least one instruction.

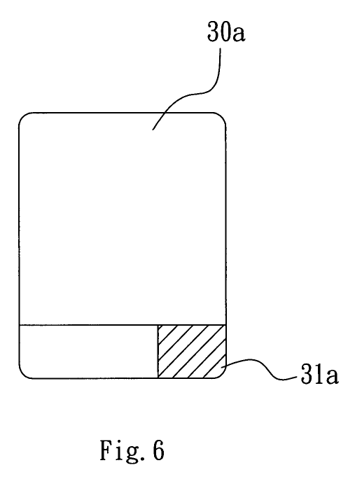

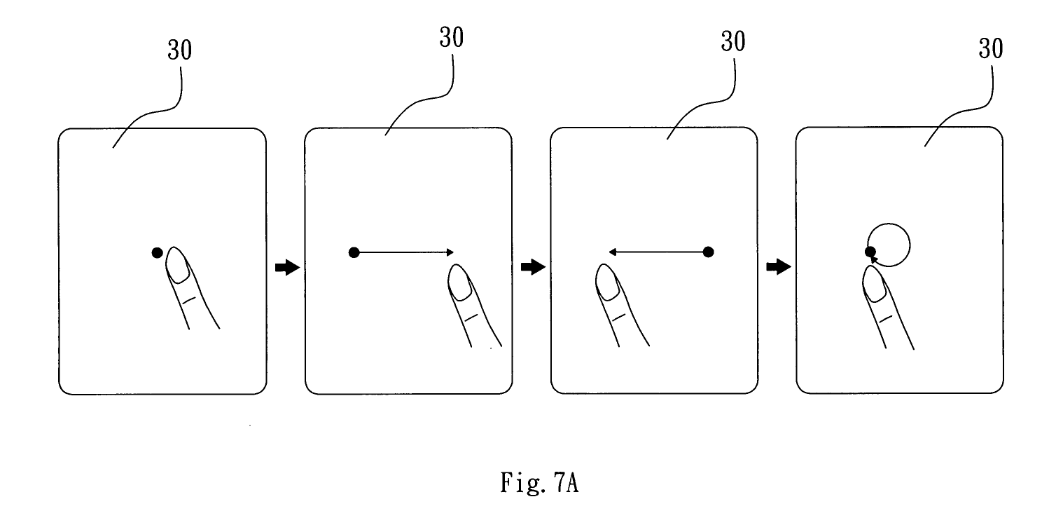

As shown in FIG. 6, in one embodiment of the present invention, the touch device 30a comprises a switch key 31a. In one embodiment of the present invention, the step of receiving at least one instruction can be, but is not limited to, the step of receiving the touch gesture, the switch key 31a, or the combination of the touch gesture and the switch key.

In one embodiment of the present invention, the switch key 31a can be, but is not limited to, a physical key disposed around the touch device 30a, or a virtual key disposed on the touch device 30a. Furthermore, the switch key can be selected by the user from options of a menu of the electronic device (not shown in figures).

Then the method performs step S82: determining whether the at least one instruction comprises a start instruction.

In one embodiment of the present invention, the start instruction is a start gesture or the abovementioned switch key 31a. In one embodiment of the present invention, the start gesture is, but is not limited to, a long-time press point (such as using a finger to press for 2 seconds), a tap, a press point, a straight line, a curved line, a closed circle (such as a circle) or a time interval (such as stopping any action for 2 seconds).

In one embodiment of the present invention, the start instruction is used for identifying whether the user is going to perform the multi single-touch operation, so as to prevent the electronic device 1 from making a wrong decision.

If the at least one instruction comprises the start instruction, the method performs step S83: determining whether the at least one instruction comprises an end instruction.

In one embodiment of the present invention, the end instruction is an end gesture or the abovementioned switch key 31a, wherein the end gesture can be, but is not limited to, a closed circle, a tap, a press point, a straight line, a curved line, a long-time press point or a time interval.

If the at least one instruction comprises the end instruction, the method performs step S84: comparing the at least one instruction with the database for determining whether the at least one instruction is an effective multi single-touch instruction.

If the at least one instruction is the effective multi single-touch instruction, the method performs step S85: performing a multi single-touch operation.

In one embodiment of the present invention, if the abovementioned instruction meets a plurality of single-touch gestures of a multi single-touch instruction stored in the database 22, the method then performs a multi single-touch operation corresponding to the multi single-touch instruction.

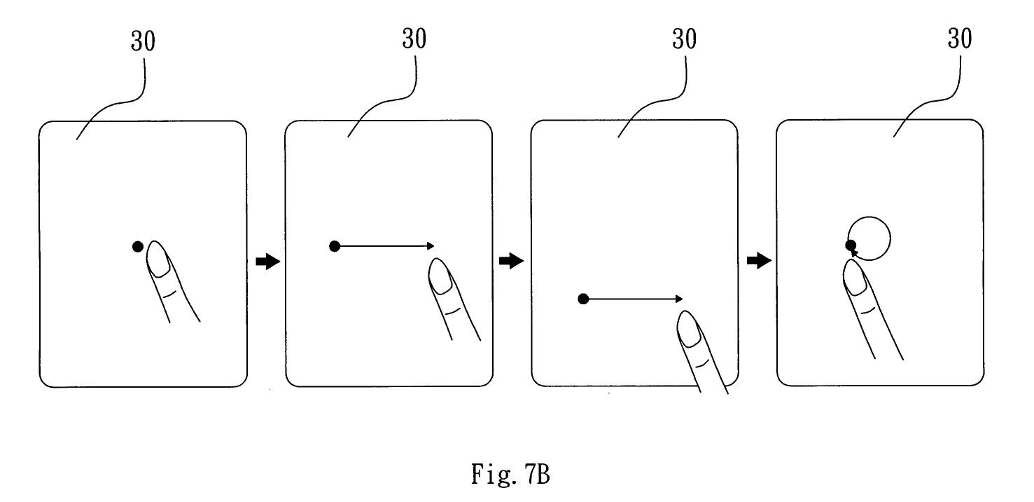

Please refer to FIG. 7A and FIG. 7B, which respectively illustrate schematic drawings showing touch gestures of the multi single-touch operation according to embodiments of the present invention.

As shown in FIG. 7A, if the user would like to perform an instruction for scaling down a frame, the instruction can be done by means of using a single finger to perform the gestures including a long-time press point, a left-to-right straight line, a right-to-left straight line and a closed circle. As shown in FIG. 7B, if the user would like to perform an instruction for turning to a next page, the instruction can be done by means of using a single finger to perform the gestures including a long-time press point, a left-to-right straight line, a left-to-right straight line and a closed circle. In one embodiment of the present invention, the start instruction is the gesture of a long-time press point, and the end instruction is the gesture of a closed circle. Therefore, the method for applying multi single-touch instruction of the present invention is capable of achieving the same effect as a multi-touch operation by means of utilizing a plurality of single-touch gestures.

Please note that in one embodiment of the present invention, it is not required that all steps (such as step S82 or S83) described above be performed. And a person skilled in the art of the present invention is aware that the steps of S81, S82, S83, S84 and S85 can be performed in varied sequences or can be performed at the same time without influencing the object of the present invention.

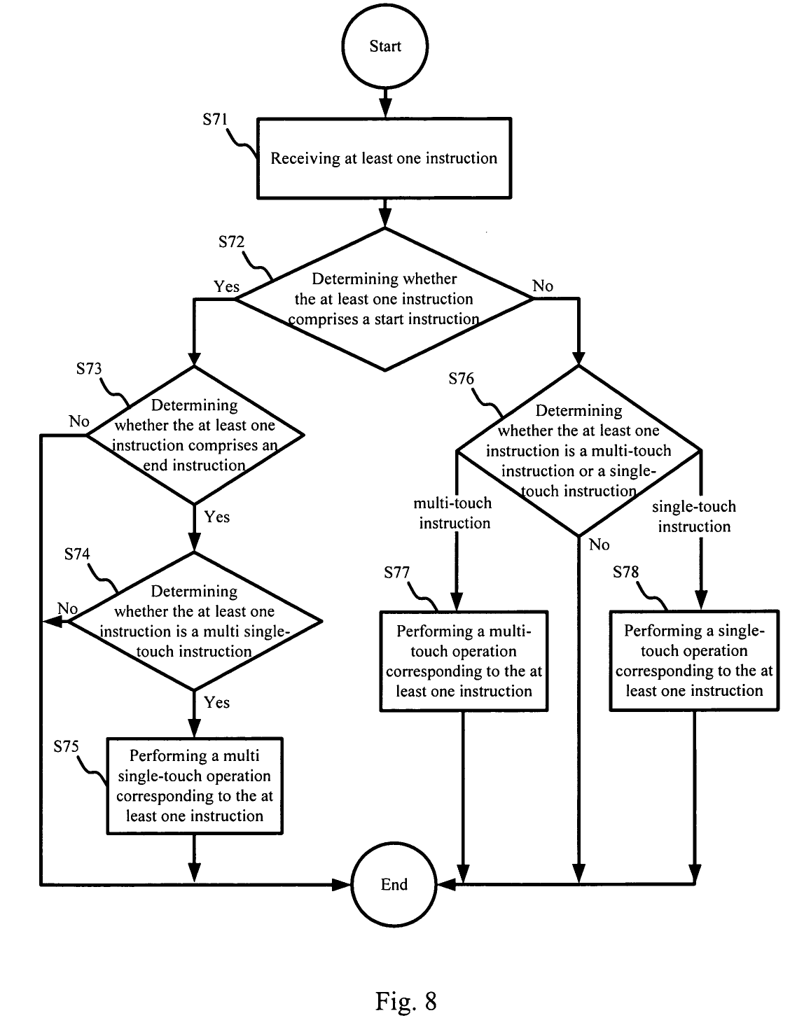

Please refer to FIG. 8, which illustrates a flowchart of a method for multiple touch modes according to one embodiment of the present invention by means of using the electronic device 1 of the present invention.

As shown in FIG. 8, the method firstly performs step S71: receiving at least one instruction. The process of receiving the at least one instruction is the same of the step described above; therefore, there is no need for further description.

Then the method performs step S72: determining whether the at least one instruction comprises a start instruction.

In one embodiment of the present invention, the start instruction is the start gesture or the switch key 31a. Please refer to the abovementioned description for details of the operation of the start instruction.

If the at least one instruction comprises the start instruction, then the method performs step S73: determining whether the at least one instruction comprises an end instruction.

Please refer to the abovementioned description for details about the operation of the end instruction. In one embodiment of the present invention, the start instruction or the end instruction is used for identifying whether the user is going to perform the multi single-touch operation, so as to prevent the electronic device 1 from making a wrong decision.

Please note that neither the start instruction nor the end instruction is a must-have element in the present invention. For example, the object of the present invention can still be achieved by only determining whether the at least one instruction comprises the start instruction. But please still note that the scope of the present invention is not limited to the above description.

If the at least one instruction comprises the start instruction and the end instruction, the method performs step S74: determining whether the at least one instruction is a multi single-touch instruction.

In one embodiment of the present invention, the method compares the at least one instruction with the database 22 for determining whether the at least one instruction is an effective multi single-touch instruction. If each of the at least one instructions meets a plurality of single-touch gestures of a multi single-touch instruction stored in the database 22, the at least one instruction is then determined as the effective multi single-touch instruction. Otherwise, the determining process of the present invention ends.

If the at least one instruction is determined as the multi single-touch instruction, the method performs step S75: performing a multi single-touch operation corresponding to the at least one instruction.

In one embodiment of the present invention, if the at least one instruction is determined as the multi single-touch instruction, the method then performs the multi single-touch operation (such as a frame-scaling-down operation or a page-turning operation) corresponding to the at least one instruction according to the database 22. In one embodiment of the present invention, a determining step can also be added for determining whether the at least one instruction is a single-touch instruction. If yes, the method performs a corresponding single-touch operation. But please note that the scope of the present invention is not limited to the above description.

If the at least one instruction does not comprises the start instruction, the method performs step S76: determining whether the at least one instruction is a multi-touch instruction or a single-touch instruction.

If the at least one instruction is determined as the multi-touch instruction, the method performs step S77: performing a multi-touch operation corresponding to the at least one instruction.

In one embodiment of the present invention, if the at least one instruction is formed by multiple clear touch gestures (for example, two fingers moving toward each other horizontally, or two fingers moving rightwards in parallel), the at least one instruction would be determined as the multi-touch instruction, and the method performs a corresponding multi-touch operation (such as a frame-scaling-down operation or a page-turning operation) according to the database 22.

If the at least one instruction is determined as the single-touch instruction, the method performs step S78: performing a single-touch operation corresponding to the at least one instruction.

Although the present invention has been explained in relation to its preferred embodiments, it is to be understood that many other possible modifications and variations can be made without departing from the spirit and scope of the invention as hereinafter claimed.

What is claimed is:

1. A method for multiple touch modes, used in an electronic device, the electronic device comprising a touch device, the method for multiple touch modes comprising the following steps:
receiving at least one instruction;
determining whether the at least one instruction comprises a start instruction;
if the at least one instruction comprises the start instruction, determining whether the at least one instruction is a multi single-touch instruction, wherein the multi single-touch instruction is a single instruction composed of a plurality of single-touch gestures; and
if the at least one instruction is determined as the multi single-touch instruction, performing a multi single-touch operation corresponding to the at least one instruction.

2. The method for multiple touch modes as claimed in claim 1, wherein the electronic device further comprises a switch key, and the at least one instruction is a touch gesture, the switch key, or the combination of the touch gesture and the switch key.

3. The method for multiple touch modes as claimed in claim 1, wherein the electronic device further comprises a switch key, and the start instruction is a start gesture or the switch key.

4. The method for multiple touch modes as claimed in claim 3, wherein the start gesture is a tap, a press point, a straight line, a curved line, a closed circle, a long-time press point or a time interval.

5. The method for multiple touch modes as claimed in claim 1, wherein the step of determining whether the at least one instruction comprises the start instruction further comprises the following step:
determining whether the at least one instruction comprises an end instruction.

6. The method for multiple touch modes claimed in claim 5, wherein:
if the at least one instruction comprises the start instruction and the end instruction, determining whether the at least one instruction is the multi single-touch instruction; and
if the at least one instruction is determined to be the multi single-touch instruction, performing the multi single-touch operation corresponding to the at least one instruction.

7. The method for multiple touch modes claimed in claim 5, wherein the electronic device further comprises a switch key, and the end instruction is an end gesture or the switch key.

8. The method for multiple touch modes as claimed in claim 7, wherein the end gesture is a tap, a press point, a straight line, a curved line, a closed circle, a long-time press point, or a time interval.

9. The method for multiple touch modes as claimed in claim 1 further comprising the following steps:
if the at least one instruction does not comprise the start instruction, determining whether the at least one instruction is a multi-touch instruction or a single-touch instruction;
if the at least one instruction is determined to be the multi-touch instruction, performing a multi-touch operation corresponding to the at least one instruction; and
if the at least one instruction is determined to be the single-touch instruction, performing a single-touch operation corresponding to the at least one instruction.

10. A method for applying multi single-touch instruction, used in an electronic device, the electronic device comprising a touch device, the method for applying multi single-touch instruction comprising the following steps:
receiving at least one instruction;
determining whether the at least one instruction comprises a start instruction;
if the at least one instruction comprises the start instruction, comparing the at least one instruction with a database for determining whether the at least one instruction is an effective multi single-touch instruction, wherein the multi single-touch instruction is a single instruction composed of a plurality of single-touch gestures; and
if the at least one instruction is the effective multi single-touch instruction, performing a multi single-touch operation corresponding to the at least one instruction.

11. The method for applying multi single-touch instruction as claimed in claim 10, wherein the electronic device further comprises a switch key, and the at least one instruction is a touch gesture, the switch key, or the combination of the touch gesture and the switch key.

12. The method for applying multi single-touch instruction as claimed in claim 10, wherein the electronic device further comprises a switch key, and the start instruction is a start gesture or the switch key.

13. The method for applying multi single-touch instruction as claimed in claim 12, wherein the start gesture is a tap, a press point, a straight line, a curved line, a closed circle, a long-time press point, or a time interval.

14. The method for applying multi single-touch instruction as claimed in claim 10 further comprising the following steps:
if the at least one instruction comprises the start instruction, determining whether the at least one instruction comprises an end instruction; and
if the at least one instruction comprises the end instruction, comparing the at least one instruction with the database for determining whether the at least one instruction is the effective multi single-touch instruction.

15. The method for applying multi single-touch instruction as claimed in claim 14, wherein the electronic device further comprises a switch key, and the end instruction is an end gesture or the switch key.

16. The method for applying multi single-touch instruction as claimed in claim 15, wherein the end gesture is a tap, a press point, a straight line, a curved line, a closed circle, a long-time press point or a time interval.

17. An electronic device, comprising:
a processor;
a storage device, electrically connected with the processor, the storage device comprising a program and a database;
a touch device, electrically connected with the processor, the touch device used for receiving a touch gesture from a user;
wherein by means of utilizing the processor to execute the program and the database, the electronic device is capable of performing the following steps:
receiving at least one instruction;
determining whether the at least one instruction comprises a start instruction;
if the at least one instruction comprises the start instruction, determining whether the at least one instruction is a multi single-touch instruction, wherein the multi single-touch instruction is a single instruction composed of a plurality of single-touch gestures; and
if the at least one instruction is determined to be the multi single-touch instruction, performing a multi single-touch operation corresponding to the at least one instruction.

18. The electronic device as claimed in claim 17, wherein the electronic device further comprises a switch key, and the at least one instruction is a touch gesture or the switch key, or the combination of the touch gesture and the switch key.

19. The electronic device as claimed in claim 17, wherein the electronic device further comprises a switch key, and the start instruction is a start gesture, the switch key.

20. The electronic device as claimed in claim 19, wherein the start gesture is a tap, a press point, a straight line, a curved line, a closed circle, a long-time press point, or a time interval.
